(19) United States
(12) Patent Application Publication
(10) Pub. No.: US 2019/0006865 A1
(43) Pub. Date: Jan. 3, 2019

(54) DATA-STERILE CHARGING INTERFACE

(71) Applicants: Christopher Allen Neergaard, Oil City, PA (US); Matthew Jeremy Russo, Franklin, PA (US)

(72) Inventors: Christopher Allen Neergaard, Oil City, PA (US); Matthew Jeremy Russo, Franklin, PA (US)

(21) Appl. No.: 16/021,224

(22) Filed: Jun. 28, 2018

Related U.S. Application Data
(60) Provisional application No. 62/526,132, filed on Jun. 28, 2017.

(51) Int. Cl. H02J 7/00

(52) U.S. Cl. CPC H02J 7/0052; H02J 2007/0062

(57) ABSTRACT

A device for providing security when the mobile device is operatively engaged with a power source during recharging is provided. The security device provides opposing male and female ends for operatively interconnecting a power source with a charging mobile device, wherein serially connected between the male and female ports of the security device is a control circuitry adapted to allow the transmission of power while preventing the transmission of data between a power source and a mobile device to be charged.

### CROSS-REFERENCE TO RELATED APPLICATION

This application claims the benefit of priority of U.S. provisional application No. 62/526,132, filed 28 Jun. 2017, the contents of which are herein incorporated by reference.

### BACKGROUND OF THE INVENTION

The present invention relates to mobile device security and, more particularly, to a device for providing security when a mobile device is operatively engaged with a power source during recharging.

Currently when you are charging a mobile device a data line operatively engages the same mobile device port the power source interfaces with, typically via a peripheral interface, such as the Universal Serial Bus (USB). Through this data line information can be transmitted through the same cable that is charging the mobile device.

As can be seen, there is a need for a device for providing mobile device security when operatively engaged with a power source. The security device provides a disconnection between the data line of the mobile device and the power source and/or its peripheral interface. Thus, when the security device is placed in line with the charging cable the mobile device will form only a power connection and no data line connection. This data disconnection prevents data form being transferred from the mobile device through the USB connection while charging the mobile device. This will allow one to charge their mobile device without the fear or someone gaining access to your personal information. This is important if you are charging your device from an unsecure location or charging station, as a when traveling through an airport.

The security device is a small device the size of a regular flash drive that provides an alternative defensive security strategy for devices with inherently limited power.

### SUMMARY OF THE INVENTION

In one aspect of the present invention, an electronic security device for preventing the transmission of data between a mobile device and power source when the mobile device is operatively engaged with a power source during recharging includes a body extending between a male portion and a female portion; and a control circuitry electrically interconnecting the male and female portions, the control circuitry configured to prevent the transmission of data between the male and female portions.

In another aspect of the present invention, an electronic security device for preventing the transmission of data between a mobile device and power source when the mobile device is operatively engaged with a power source during recharging includes a body extending between a male portion and a female portion a length between one and four inches; a control circuitry electrically serially interconnecting the male and female portions, the control circuitry configured to prevent the transmission of data between the male and female portions, wherein the female portion is dimensioned to operatively associate with a male end of a peripheral interface, and wherein the male portion is dimensioned to operatively associate with a female port adapted for operatively engaging a male end of a peripheral interface; and an indicator light configured to activate when the control circuitry is electrically interconnecting the male and female portions.

In yet another aspect of the present invention, a method of preventing data transmitting between a power source and a mobile device when the mobile device is operatively engaged with the power source to charge therefrom, includes the steps of: providing the above-mentioned electronic security device; operatively associating the male portion with a power port of the power source; operatively associating the female portion with a male end of a peripheral interface; and operatively associating an opposing end of the peripheral interface with the mobile device to be charged.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is an exploded perspective view of an exemplary embodiment of the present invention;

FIG. 3 is a schematic view of an exemplary embodiment of the present invention; and

FIG. 4 is a perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a device for providing security when the mobile device is operatively engaged with a power source during recharging. The security device provides opposing male and female ends for operatively interconnecting a power source with a charging mobile device, wherein serially connected between the male and female ports of the security device is a control circuitry adapted to allow the transmission of power while preventing the transmission of data between the power source and charging mobile device.

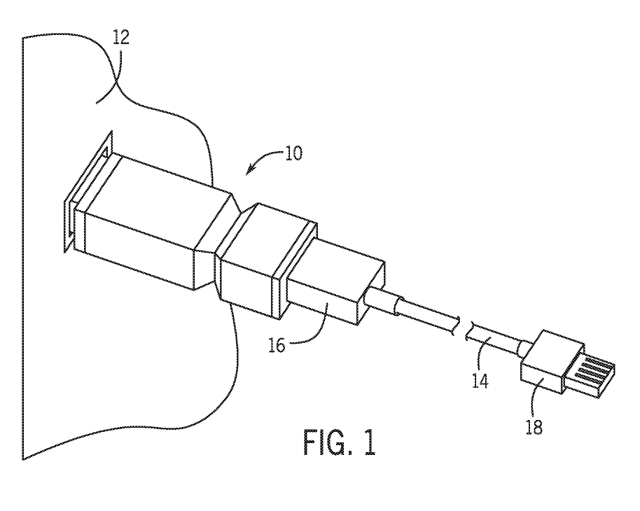

Referring to FIGS. 1 through 4, the present invention may include a security device 10 for providing security when the mobile device is operatively engaged with a power source during recharging. The security device 10 can take the form of a plug computer with embedded control circuity 22 to prevent the transmission of data between a mobile device (not shown) coupled to charging device 12 or power source 24.

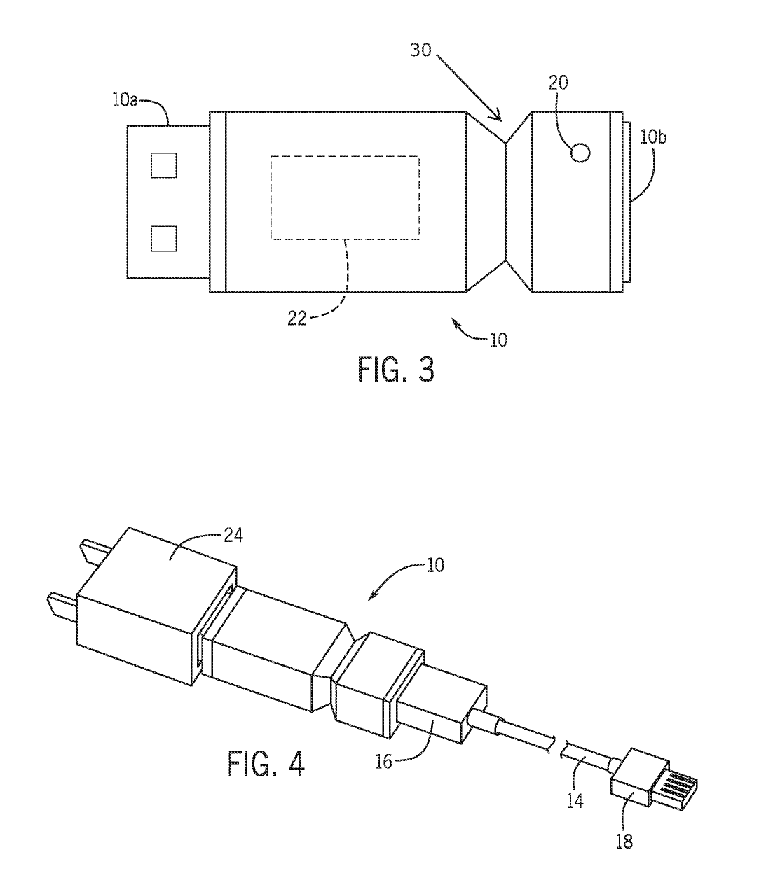

The security device 10 may extend between a male portion 10a and a female portion 10b, wherein the control circuity 22 is electrically connected in series between the two portions 10a and 10b, as illustrated in FIG. 3. The control circuitry 22 is adapted to prevent data being transferred from the charging device 10, in essence by severing the electrical connection of data lines intrinsic to power ports of both charging devices 12, some power sources 24, and peripheral interfaces 14. The security device 10 body may provide a tapered bottle neck portion 30 between a male and female portions 10a and 10b for facilitating handling the security device 10 body which may extend for a length between one and five inches.

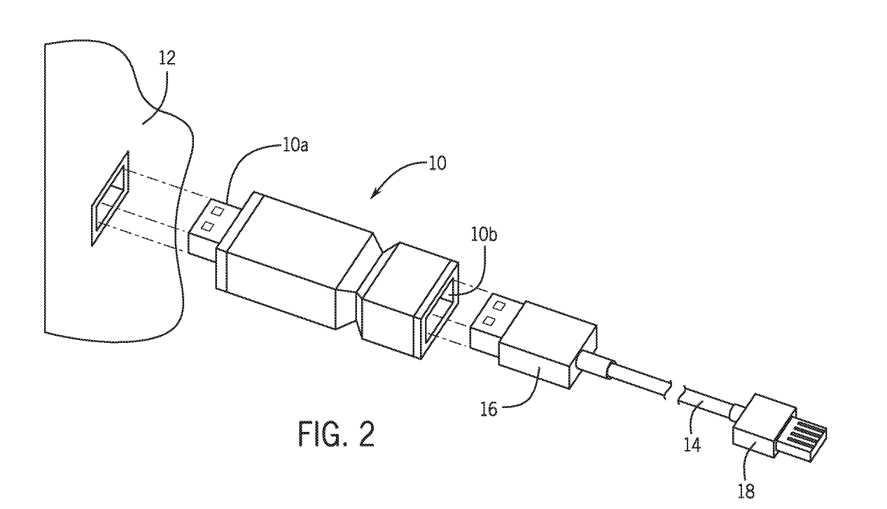

The security device 10 may be the size of a regular flash drive that provides security while you are charging your electronic devices (phone, tablet, etc.). The male portion 10a may be adapted to operatively engage a power port (typically USB compatible) of the charging device 12 or of the power source 24, as illustrated in FIG. 2 and FIG. 4, respectively. The female portion 10b may be adapted to engage a male plug 16 of a charging cable 14 or peripheral interface, such as a USB male end, as illustrated in FIGS. 1 and 2. The charging cable 14 interconnects its male plug 16 and a device plug 18, which may be adapted to plug into the female USB-compatible ports of the mobile device to be charged. There may be an indicator light 20 on the security device 10 to show that is functioning properly.

A method of using the present invention may include the following. The security device 10 disclosed above may be provided. The male portion 10a of the security device 10 may be inserted into the power source 24 or the charging device 12. The power source 24 may be a stand-alone unit, a public charging station, a computer, or the like, that may include a charger adapter. After review if the indicator light 20 indicates if the present invention is functioning properly, the security device 10 may be placed in line with the charging cable 14 by electrically connecting (“plugged into”) the female portion 10b of the security device 10 to the male plug of the charging cable. As a result, only a power charge will be transmitted from the charging device 12/power source 24, and no data can be transferred through the USB port of the operatively interconnected security device 10, providing security from anyone or anything trying to gain access to the personal information retrievably stored on the charging device 12.

It should be understood, of course, that the foregoing relates to exemplary embodiments of the invention and that modifications may be made without departing from the spirit and scope of the invention as set forth in the following claims.

What is claimed is:

1. An electronic security device for preventing the transmission of data between a mobile device and power source when the mobile device is operatively engaged with a power source during recharging, comprising:
a body extending between a male portion and a female portion; and
a control circuitry electrically interconnecting the male and female portions, the control circuitry configured to prevent the transmission of data between the male and female portions.

2. The electronic security device of claim 1, wherein the control circuitry is in series with the male and female portion.

3. The electronic security device of claim 1, wherein the female portion is dimensioned to operatively associate with a male end of a peripheral interface.

4. The electronic security device of claim 3, wherein the peripheral interface is a Universal Serial Bus.

5. The electronic security device of claim 1, further comprising an indicator light configured to activate when the control circuitry is electrically interconnecting the male and female portions.

6. The electronic security device of claim 1, wherein the body is between one and four inches in length.

7. The electronic security device of claim 1, wherein the male portion is dimensioned to operatively associate with a female port adapted for operatively engaging a male end of a peripheral interface.

8. The electronic security device of claim 1, wherein the body has a tapered bottle neck portion between the male and female portions.

9. An electronic security device for preventing the transmission of data between a mobile device and power source when the mobile device is operatively engaged with a power source during recharging, comprising:
a body extending between a male portion and a female portion a length between one and four inches;
a control circuitry electrically serially interconnecting the male and female portions, the control circuitry configured to prevent the transmission of data between the male and female portions, wherein the female portion is dimensioned to operatively associate with a male end of a peripheral interface, and wherein the male portion is dimensioned to operatively associate with a female port adapted for operatively engaging a male end of a peripheral interface; and
an indicator light configured to activate when the control circuitry is electrically interconnecting the male and female portions.

10. The electronic security device of claim 9, wherein the body has a tapered bottle neck portion between the male and female portions.

11. A method of preventing data transmitting between a power source and a mobile device when the mobile device is operatively engaged with the power source to charge therefrom, comprising the steps of:
providing an electronic security device of claim 1;
operatively associating the male portion with a power port of the power source;
operatively associating the female portion with a male end of a peripheral interface; and
operatively associating an opposing end of the peripheral interface with the mobile device to be charged.
